(19) United States
(12) Patent Application Publication
(10) Pub. No.: US 2025/0366657 A1
(43) Pub. Date: Dec. 4, 2025

(54) METHOD AND APPARATUS FOR AUTOMATED GRIDDLE AND PLATEN CONTROL

(71) Applicant: AccuTemp Products, Inc., Fort Wayne, IN (US)

(72) Inventor: Justin Mullins, New Haven, IN (US)

(21) Appl. No.: 18/675,369

(22) Filed: May 28, 2024

(51) Int. Cl. A47J 36/32; A47J 37/06; G01P 15/18

(52) U.S. Cl. CPC A47J 36/32; A47J 37/067; G01P 15/18

(57) ABSTRACT

A system for determining whether a position of an upper platen of a griddle is disclosed as comprising: a processor; and an accelerometer mounted to the upper platen and configured to provide output signals to the processor. The processor is configured to determine whether the position of the upper platen by calculating an inclination angle of the upper platen relative to a cooking surface of the griddle using the output signals from the accelerometer, determining that the upper platen is in a raised position if the inclination angle is greater than or equal to a predetermined threshold; and determining that the upper platen is in a lowered position if the inclination angle is less than the predetermined threshold.

### TECHNICAL FIELD

The present disclosure is directed to griddles, and more particularly to a griddle having an upper platen with a sensor that automatically detects whether the upper platen is in a raised or lowered position.

### BACKGROUND

Using a conventional griddle with an upper platen, an operator must manually control certain steps in the cooking process, such as setting timers that control operation of the griddle. Certain timers may be set when the upper platen is in the lowered, cooking position. It would be desirable to automatically determine when the upper platen is in the lowered, cooking position and automatically set timers at appropriate steps in the cooking process in response to that determination, thereby reducing the workload of the operator and the opportunities for operator error.

### SUMMARY

The present disclosure provides a system for determining whether an upper platen of a griddle is in a raised position wherein the upper platen is spaced apart from a cooking surface of the griddle or a lowered position wherein the upper platen is adjacent the cooking surface, the system comprising: at least one processor configured to execute a plurality of instructions; and an accelerometer mounted to the upper platen and configured to provide output signals to the at least one processor; wherein the at least one processor is configured to execute the plurality of instructions to determine whether the upper platen is in the raised position or the lowered position by calculating an inclination angle of the upper platen relative to the cooking surface using the output signals from the accelerometer, determining that the upper platen is in the raised position if the inclination angle is greater than or equal to a predetermined threshold, and determining that the upper platen is in the lowered position if the inclination angle is less than the predetermined threshold; and wherein the at least one processor is configured to automatically initiate at least one operation of the griddle in response to determining that the upper platen is in the lowered position. In one aspect of this embodiment, the at least one operation includes resetting a timer and causing a display to indicate a count down time from a preset time. In another aspect, the electrical system further comprises: a controller board including at least one second processor for controlling operation of the upper platen; and a transistor connected to the at least one processor; wherein the at least one processor is configured to provide a signal to the transistor upon determining that the upper platen is in the lowered position, which causes the transistor to provide a signal to the at least one second processor on the controller board. In another aspect, the accelerometer is a three-axis accelerometer and the output signals include an x-axis signal, a y-axis signal and a z-axis signal. In yet another aspect, the at least one processor is configured to assume that the upper platen is in the lowered position upon power being applied to the electrical system. In another aspect, the at least one processor determines whether the upper platen is in the raised position or the lowered position by sampling the output signals from the accelerometer once every sampling period. In a variant of this aspect, before calculating the inclination angle of the upper platen, the at least one processor calculates, every sampling period, a total acceleration of the accelerometer to determine if the upper platen is in motion. In another variant, the at least one processor determines that the upper platen is in motion when the total acceleration is outside a total acceleration range of +/−0.1 g from a neutral acceleration measurement. In a still further variant, the at least one processor discards the output signals from any sampling period wherein the total acceleration is outside the total acceleration range. In another variant, the total acceleration is a square root of a sum of the output signals squared, the output signals including an x-axis signal, a y-axis signal and a z-axis signal. In another variant, the at least one processor calculates an instantaneous inclination angle for use in determining the inclination angle, the instantaneous inclination angle being an inverse tangent of the x-axis signal divided by the z-axis signal. In a further variant, the at least one processor calculates the instantaneous inclination angle by sampling the output signals once every sampling period, the at least one processor being configured to calculate an average inclination angle every sampling period from the instantaneous inclination angle. In a further variant, the average inclination angle for each sampling period is 90% of an average inclination angle for a prior sampling period plus 10% of the instantaneous inclination angle of a current sampling period. In a further variant, the at least one processor determines that the inclination angle indicates that the upper platen is in the lowered position if the average inclination angle of a current sampling period is less than a threshold angle. In a further variant, the threshold angle is approximately seven degrees. In a further variant, the at least one processor determines that the inclination angle corresponds to the upper platen being in the lowered position after the average inclination angle of each of a predetermined number of successive sampling periods is less than the threshold angle.

In another embodiment, the present disclosure provides an upper platen assembly for a griddle, comprising: a plurality of arms pivotally connected to the griddle; an upper platen carried by the plurality of arms between a lowered position wherein the upper platen is adjacent a cooking surface of the griddle and a raised position wherein the upper platen is spaced apart from the cooking surface; and a control assembly coupled to and movable with the upper platen, the control assembly including an electrical system comprising: at least one processor configured to execute a plurality of instructions; and an accelerometer configured to provide output signals to the at least one processor; wherein the at least one processor is configured to execute the plurality of instructions to determine whether the upper platen is in the raised position or the lowered position by calculating an inclination angle of the upper platen relative to the cooking surface using the output signals from the accelerometer, determining that the upper platen is in the raised position if the inclination angle is greater than or equal to a predetermined threshold, and determining that the upper platen is in the lowered position if the inclination angle is less than the predetermined threshold; and wherein the at least one processor is configured to automatically initiate at least one operation of the griddle in response to determining that the upper platen is in the lowered position.

In yet another embodiment, the present disclosure provides a method for determining a position of an upper platen of a griddle relative to a cooking surface of the griddle, comprising: sampling, by at least one processor, output signals from an accelerometer mounted to the upper platen, once every sampling period; determining, by the at least one processor once every sampling period, whether the upper platen is in a raised position or a lowered position by: calculating an instantaneous inclination angle from the output signals; calculating an average inclination angle from the instantaneous inclination angle; determining that the upper platen is in a raised position when the average inclination angle is greater than or equal to a threshold angle; and determining that the upper platen is in a lowered position when the average inclination angle is less than the threshold angle. In one aspect of this embodiment, determining, by the at least one processor once every sampling period, whether the upper platen is in the raised position or the lowered position further comprises: calculating a total acceleration from the output signals; and discarding the output signals for a current sampling period in response to the total acceleration falling outside a total acceleration range. In another aspect, determining that the upper platen is in a raised position includes determining that the average inclination angle is greater than or equal to the threshold angle for each of a predetermined number of successive sampling periods.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a side view of a griddle having an upper platen assembly in a lowered position;

FIG. 2 is a side view of the griddle of FIG. 1 with the upper platen assembly in a raised position;

FIG. 3 is a perspective view of an upper griddle assembly according to an embodiment of the present disclosure;

FIG. 4 is an exploded perspective view of the upper griddle assembly of FIG. 3;

FIG. 5 is a top plan view of a control panel according to the present disclosure;

FIG. 6 is a schematic diagram of an electrical system for an upper griddle assembly according to one embodiment of the present disclosure;

FIG. 7 is a high-level block diagram of an algorithm according to one embodiment of the present invention; and

FIG. 8 is a flow chart depicting a method of determining a position of an upper griddle according to one embodiment of the present disclosure.

Corresponding reference characters indicate corresponding parts throughout the several views. The exemplification set out herein illustrates an embodiment of the invention, the embodiment disclosed below is not intended to be exhaustive or to be construed as limiting the scope of the invention in any manner.

### DETAILED DESCRIPTION

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrative devices and described methods and further applications of the principles of the invention which would normally occur to one skilled in the art to which the invention relates.

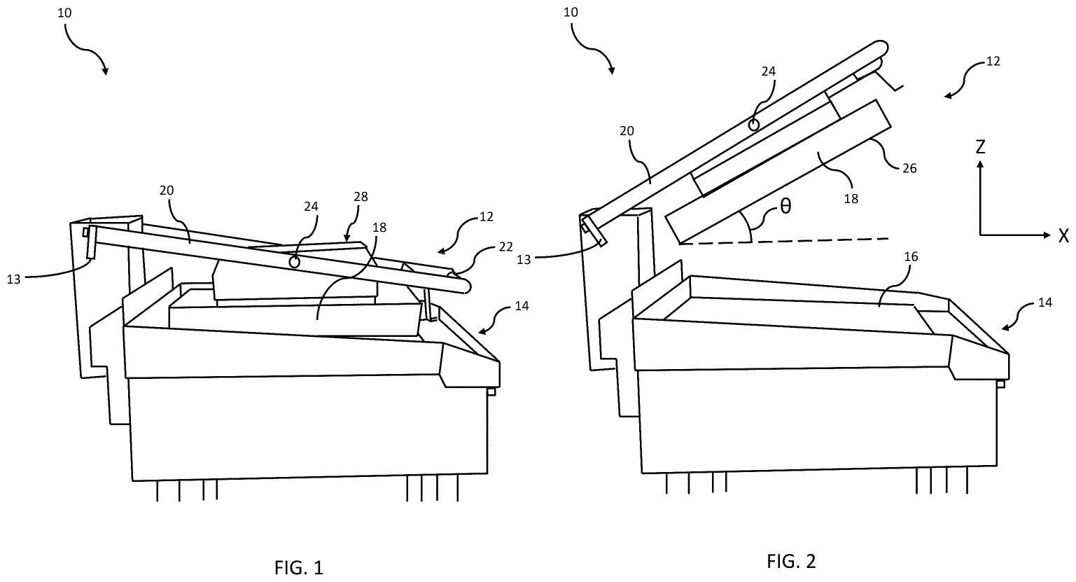

FIG. 1 depicts a griddle 10 having an upper platen assembly 12 attached thereto. The griddle 10 includes, among other things, an upper cooking surface 16 (FIG. 2) which is heated, for example, by steam generated in a chamber below the upper cooking surface 16 by one or more heaters as is known in the art. The upper platen assembly 12 generally includes an upper platen 18 supported by a pair of arms 20 which are connected to the griddle 10 at a pair of pivot connections 13 that enable the arms 20 to pivot about a pivot axis. In certain embodiments, the upper platen 18 is heated. A handle 22 extends between the arms 20 at their distal ends to permit the operator to grasp the handle 22 to raise and lower the upper platen 18. The upper platen 18 is suspended from the arms 20 by a shaft 24 extending between bearings (not shown) in the arms 20. In FIG. 1, the upper platen 18 is shown in the lowered, cooking position wherein a lower surface 26 of the upper platen 18 is adjacent the upper cooking surface 16 to permit cooking of one or more food items positioned in the gap between the upper platen 18 and the cooking surface 16.

FIG. 2 depicts the upper platen assembly 12 with the upper platen 18 in the raised position. In certain embodiments, the lower surface 26 of the upper platen 18 forms an angle θ with the cooking surface 16 of approximately 30 degrees when the upper platen 18 is in the raised position. In other embodiments, the angle θ is less than or greater than 30 degrees. As such, as the upper platen 18 is raised and lowered, it travels substantially along an arc relative to the x-axis and the z-axis as labeled in FIG. 2.

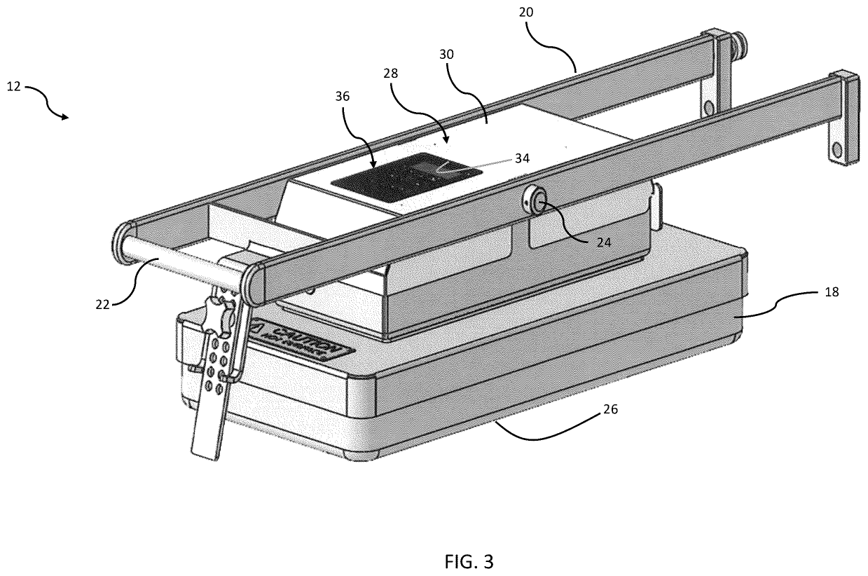

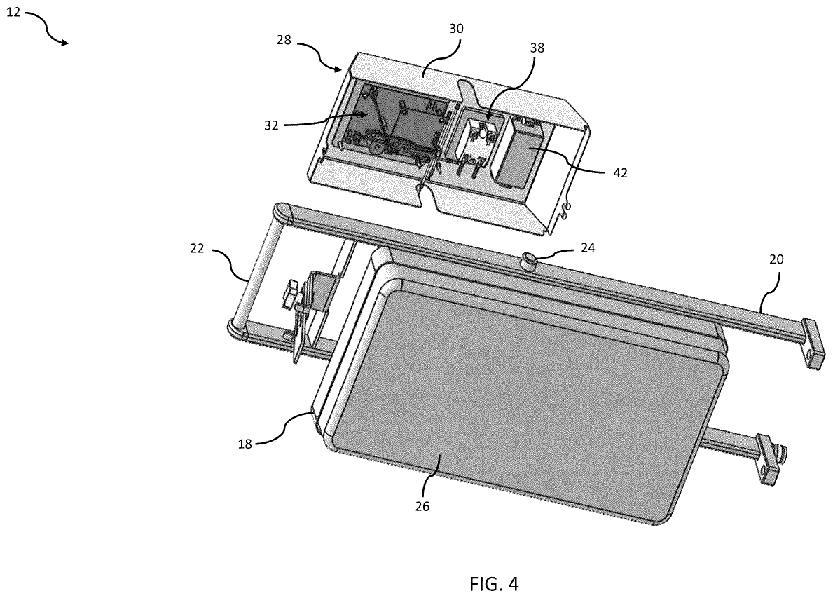

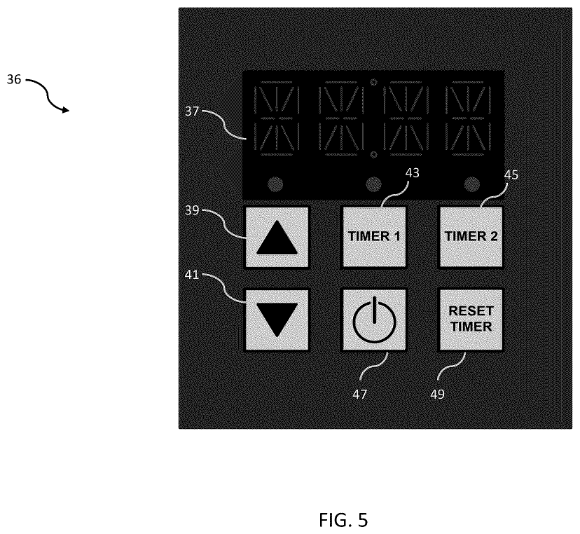

Referring now to FIGS. 3 and 4, another view of the upper platen assembly 12 is provided showing a control assembly 28 mounted to the upper platen 18. The control assembly 28 generally includes a housing 30 that encloses and supports a controller board 32 (FIG. 4) for controlling operation of the upper platen 18. The housing 30 includes an opening 34 through which a control panel 36 of the controller board 32 is visible.

The control panel 36, depicted in FIG. 5, includes a plurality of alphanumeric display characters 37, an up button 39, a down button 41, a timer one button 43, a timer two button 45, a power button 47 and a timer reset button 49. The power button 47 permits the operator to turn the upper platen assembly 12 on and off. When the power button 47 is activated, the alphanumeric display characters 37 indicate the current temperature of the upper platen 18. The operator may adjust the temperature up and/or down using the up button 39 and/or the down button 41. Two preset timer values are available to the operator and are selected by pressing the timer one button 43 or the timer two button 45. The timer reset button 49 permits the operator to start and/or stop a manual timer operation. In certain embodiments, as described below, an automatic timer sequence is activated by lowering the upper platen 18 to the lowered position.

As shown in FIG. 4, the controller board 32 includes at least one microcontroller 44 with an integrated memory device 45, along with a plurality of other electrical components to facilitate control of the upper platen 18, power conditioning, interfacing with the control panel 36, etc. It should be understood that the microcontroller 44 and memory device 45 may be replaced with a microprocessor and an external memory device or any of a variety of other control implementations. According to one embodiment of the present disclosure, the housing 30 also supports and encloses an inclination module 38 which is used to determine the position of the upper platen 18 relative to the cooking surface 16 as is further described below.

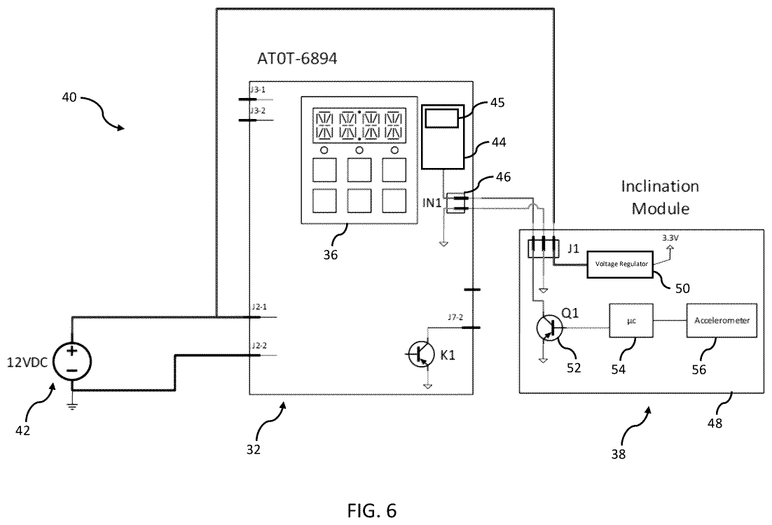

Referring now to FIG. 6, a simplified schematic diagram of the electrical system 40 of the upper platen assembly 12 is shown. The electrical system 40 generally includes a power source 42, the controller board 32, and the inclination module 38. In one embodiment, the power source 42 is a 12-volt DC power supply, while other voltages may be used. The 12 VDC signal of the power source 42 is provided to the controller board 32 at the J2-1 connection and to the inclination module 38 at the J1 connector on the inclination module 38. As shown, the controller board 32 includes the display 36 discussed above, the microcontroller 44, an inclination connector 46 and a transistor K1. The transistor K1 is a discrete output to a solid-state relay (not shown) that controls a heating element (not shown) of the upper platen 18. In certain embodiments, the transistor K1 may be used to cycle the heater (not shown) of the upper platen 18 to a lower temperature (or off) if the upper platen 18 is determined to be in a raised position as described below for a predetermined period of time, thereby increasing the safety of use of the upper platen assembly 12.

The inclination module 38 includes a printed circuit board 48 to which is mounted the J1 connector, a voltage regulator 50, an open collector transistor 52, a processor 54, a memory device 55, and an accelerometer 56. The memory device 55 includes a plurality of instructions that, when executed by the processor 54, cause the processor 54 to perform a variety of functions as described herein. Digital ground is provided from the controller board 32 through the inclination connector 46 to the J1 connector of the inclination module 38. The output signal of the inclination module 38 (discussed further below) is provided from the transistor 52, through the J1 connector, to the inclination connector 46, which provides the output signal to the microcontroller 44. The 12 VDC signal provided at the J1 connector is routed to the regulator 50 which, in an exemplary embodiment, converts the signal to a 3.3 volt power signal for the components of the inclination module 38. In certain embodiments, the accelerometer 56 is a three-axis accelerometer that provides an x-axis output signal, a y-axis output signal and a z-axis output signal depending upon the orientation of the accelerometer 56 relative to the force of gravity. Any of a plurality of different accelerometers may be used, such as the type typically found in smart phones. In alternative embodiments, accelerometers having fewer than three axes may be used as long as the accelerometer is gravity sensitive. The output signals of the accelerometer 56 are provided to the processor 54 which executes an algorithm (described below) to determine the inclination angle θ of the upper platen 18 relative to the cooking surface 16. The processor 54 provides an output signal to the base of the transistor 52 that indicates the position of the upper platen 18 based upon the output signals of the accelerometer 56 as is further described below. The output signal of the processor 54 either turns the transistor 52 ON or OFF. The collector of the transistor 52 provides this binary ON or OFF signal through the J1 connector to the inclination connector 46 of the controller board 32, and the microcontroller 44 receives the signal from the inclination connector 46

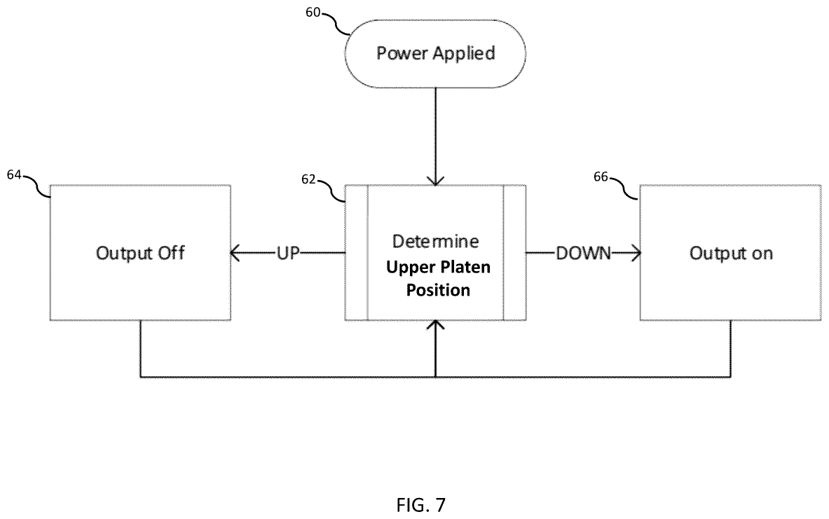

Referring now to FIG. 7, a high-level flow chart depicting operation of the upper platen assembly 12 is shown. Block 60 depicts power being supplied to the inclination module 38. At block 62 the processor 54 of the inclination module 38 begins sampling the output signals from the accelerometer 56 that map to the x-axis and the z-axis shown in FIG. 2. The output signals are used by the processor 54 to determine the inclination angle θ of the upper platen 18 as is further described below. The inclination angle θ indicates whether the upper platen 18 is in the raised position or the lowered position. If the inclination angle θ indicates that the upper platen 18 is in the raised position as is further described below, at block 64 the processor 54 disables the output of the transistor 52 of the inclination module 38 as is described below. On the other hand, if the inclination angle θ indicates that the upper platen 18 is in the lowered position, at block 66 the processor 54 enables the output of the transistor 52 of the inclination module 38 as is described below.

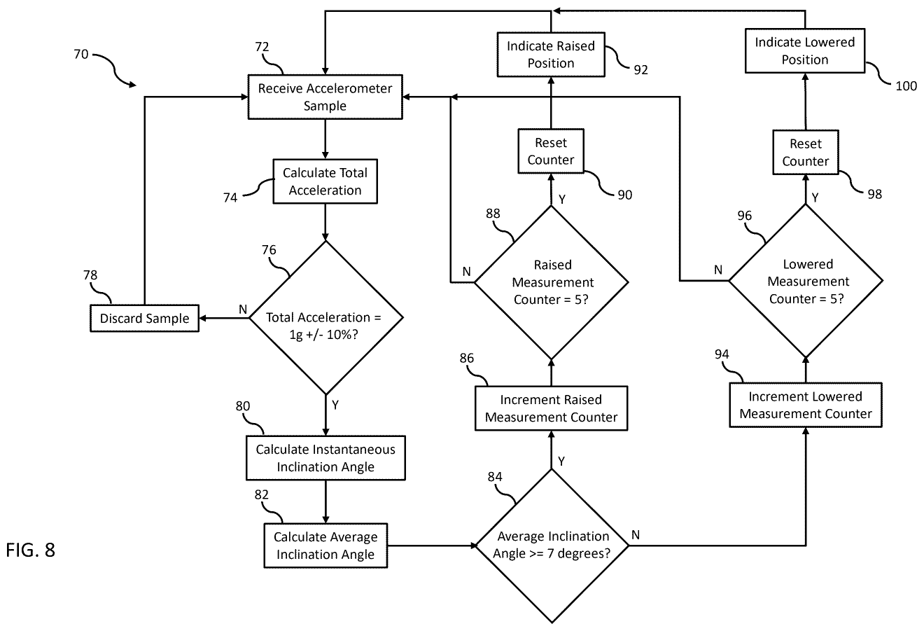

Referring now to FIG. 8, a more detailed flow chart depicting a method 70 of determining whether the upper platen 18 is in the raised position or the lowered position is shown. After power up (at block 72), the processor 54 of the inclination module 38 begins sampling the output signals from the accelerometer 56 to determine the inclination angle θ of the upper platen 18. The inclination calculation is used to determine if the upper platen 18 is in the raised or the lowered position. As indicated above, after power is applied to the inclination module 38, the processor 54 assumes that the upper platen 18 is in the lowered position. Then, at block 72, the processor 54 begins sampling the accelerometer 56, receiving a sample once every sampling period. In certain embodiments, the sampling period is 50 ms. In other embodiments, the sampling period is slower or faster than every 50 ms.

According to an exemplary embodiment, the inclination angle calculation assumes that gravity is the only force acting on the accelerometer 56. In operation, however, the upper platen assembly 12 (and therefore the accelerometer 56) may be subject to other forces as the upper platen assembly 12 is raised and lowered. To improve the accuracy of the inclination sensing, calculations made while the upper platen 18 is in motion should be rejected. Thus, in certain embodiments, before the inclination angle θ is calculated, the processor 54 calculates the total acceleration of the accelerometer 56 according to the following equation:

$${a}_{total} = \overline{√ {a}_{x}^{2} + {a}_{y}^{2} + {a}_{z}^{2}}$$

where aₓ is the x-axis output of the accelerometer 56, a_{y} is the y-axis output of the accelerometer 56 and a_{z} is the z-axis output of the accelerometer 56. At block 76, the processor 54 determines whether the total acceleration of the accelerometer 56 is within a total acceleration range about 1 g (indicating that the upper platen 18 is substantially stationary). In certain embodiments, if the total acceleration aₜₒₜₐₗ is not within +/−10% of 1 g from a neutral accelerometer reading, then the reading is rejected as indicated by block 78.

If aₜₒₜₐₗ is within +/−10% of 1 g, then an instantaneous inclination angle θ is calculated by the processor 54 at block 80 according to the following equation:

$$θ = {tan}^{- 1} ( {a}_{x} / {a}_{z} ) .$$

It should be understood that in alternative embodiments the instantaneous inclination angle θ may be calculated using other trigonometric functions such as cosine or sine functions. To prevent rapid switching of the transistor 52 and increase accuracy of the determination of the position of the upper platen 18, in certain embodiments the processor 54 averages the inclination angle θ at block 82 according to the following equation:

$${θ}_{next avg .} = 0.9 * {θ}_{current avg .} + 0.1 * {θ}_{instantaneous}$$

It should be understood that a variety of different sampling filter equations may also be used to prevent rapid switching of the transistor 52 as long as the sum of the coefficients equals 1.0.

At block 84 the processor 54 determines whether the average inclination angle θ is less than or equal to a threshold angle which indicates that the upper platen 18 is in the raised position. In an exemplary embodiment, the threshold angle is seven degrees. In other embodiments, the threshold angle may be greater than or less than seven degrees. If the average inclination angle θ is greater than or equal to the threshold angle, then at block 86 the processor 54 increments a raised measurement counter. In certain embodiments, the processor 54 establishes that the inclination angle θ corresponds to the position of the upper platen 18 (i.e., the raised or lowered position) after the average inclination angle θ, for a predetermined number of successive sampling periods, remains either less than the threshold angle or greater than or equal to the threshold angle. In certain embodiments, the predetermined number of successive sampling periods is five. In other embodiments, more or fewer successive calculations may be used. If, at block 88, the processor 54 determines that the raised measurement counter does not equal five, then the method 70 returns to block 72 where another sample of the output of the accelerometer 56 is taken. If, on the other hand, the processor 54 determines at block 88 that the raised measurement counter equals five, then the processor 54 resets the raised measurement counter at block 90. Then, at block 92, the processor 54 deactivates the transistor 52 such that the signal to the microcontroller 44 of the controller board 32 floats high, indicating to the microcontroller 44 that the upper platen 18 is in the raised position. The method 70 then returns to block 72 where sampling of the accelerometer 56 continues.

If the processor 54 determines at block 84 that the average inclination angle θ is less than the threshold of seven degrees, indicating that the upper platen 18 is in the lowered position, then the processor 54 increments a lowered measurement counter at block 94. At block 96 the processor 54 determines whether the lowered measurement counter equals five, which correlates to five successive calculations of the inclination angle θ indicating that the upper platen 18 is in the lowered position. If the lowered measurement counter does not equal five at block 96, then the method 70 returns to block 72 where another sample of the output of the accelerometer 56 is taken. If, on the other hand, the processor 54 determines at block 96 that the lowered measurement counter equals five, then the processor 54 resets the lowered measurement counter at block 98. Then, at block 100, the processor 54 outputs a signal to the base of the transistor 52 which causes the transistor 52 to conduct, providing a ground signal to the inclination connector 46 through the J1 connector of the inclination module 38. This signals to the microcontroller 44 of the controller board 32 that the inclination angle θ is less than the threshold and the upper platen 18 is in the lowered position. The method 70 then returns to block 72 where the sampling of the accelerometer 56 continues. While an exemplary method 70 is described above, it should be understood that the various steps do not necessarily need to be performed in the depicted order, certain additional steps or sub-steps may be incorporated, and certain steps may be omitted in various embodiments of the method.

Depending upon the indication to the microcontroller 44 from the inclination module 38 of the position of the upper platen 18, the microcontroller 44 may take various actions to further automate the operation of the griddle 10. For example, the microcontroller 44 may automatically reset the timer reset associated with the timer reset button 45 and cause the alphanumeric display characters 37 to begin displaying a count down from a preset time. This time may be used to determine when a selected cooking time has been reached, an event which may be accompanied by a notification and/or deactivation of the heater(s) of the upper platen 18.

While the systems and methods according to the present disclosure have been described through exemplary embodiments, it should be understood that various modifications are contemplated by the present disclosure. For example, the inclination module 38 may be integrated into the controller board 32, or the accelerometer 56 may be integrated into the controller board 32. Additionally, the principles of the present disclosure may be adapted to griddles with upper platens having more than one axis of rotation, such as up to three axes of rotation. In certain embodiments, the acceleration data could be repeatedly calibrated relative to a starting position or set of positions as reference location(s), and used mathematically to infer velocity and relative orientation of the upper platen 18 in three-dimensional space. This information could then be used further by the controller board 32 for various tasks, such as, but not limited to, further automating steps in cooking process, estimating cumulative wear of sensitive mechanical components of the upper platen, or, in embodiments using a two or three axis accelerometer, an improper arm installation alarm may be triggered.

Any directional references used with respect to any of the figures, such as right or left, up or down, or top or bottom, are intended for convenience of description, and do not limit the present disclosure or any of its components to any particular positional or spatial orientation. Additionally, any reference to rotation in a clockwise direction or a counter-clockwise direction is simply illustrative. Any such rotation may be implemented in the reverse direction as that described herein.

Although the foregoing text sets forth a detailed description of embodiments of the disclosure, it should be understood that the legal scope of the invention is defined by the words of the claims set forth at the end of this patent and equivalents. The detailed description is to be construed as exemplary only and does not describe every possible embodiment. Numerous alternative embodiments may be implemented, using either current technology or technology developed after the filing date of this patent, which would still fall within the scope of the claims.

The following additional considerations apply to the foregoing description. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112 (f) unless traditional means-plus-function language is expressly recited, such as “means for” or “step for” language being explicitly recited in the claim(s).

What is claimed is:

1. A system for determining whether an upper platen of a griddle is in a raised position wherein the upper platen is spaced apart from a cooking surface of the griddle or a lowered position wherein the upper platen is adjacent the cooking surface, the system comprising:
at least one processor configured to execute a plurality of instructions; and
an accelerometer mounted to the upper platen and configured to provide output signals to the at least one processor;
wherein the at least one processor is configured to execute the plurality of instructions to determine whether the upper platen is in the raised position or the lowered position by calculating an inclination angle of the upper platen relative to the cooking surface using the output signals from the accelerometer, determining that the upper platen is in the raised position if the inclination angle is greater than or equal to a predetermined threshold, and determining that the upper platen is in the lowered position if the inclination angle is less than the predetermined threshold; and
wherein the at least one processor is configured to automatically initiate at least one operation of the griddle in response to determining that the upper platen is in the lowered position.

2. The upper platen assembly of claim 1, wherein the at least one operation includes resetting a timer and causing a display to indicate a count down time from a preset time.

3. The upper platen assembly of claim 1, wherein the electrical system further comprises:
a controller board including at least one second processor for controlling operation of the upper platen; and
a transistor connected to the at least one processor;
wherein the at least one processor is configured to provide a signal to the transistor upon determining that the upper platen is in the lowered position, which causes the transistor to provide a signal to the at least one second processor on the controller board.

4. The upper platen assembly of claim 1, wherein the accelerometer is a three-axis accelerometer and the output signals include an x-axis signal, a y-axis signal and a z-axis signal.

5. The upper platen assembly of claim 1, wherein the at least one processor is configured to assume that the upper platen is in the lowered position upon power being applied to the electrical system.

6. The upper platen assembly of claim 1, wherein the at least one processor determines whether the upper platen is in the raised position or the lowered position by sampling the output signals from the accelerometer once every sampling period.

7. The upper platen assembly of claim 6, wherein, before calculating the inclination angle of the upper platen, the at least one processor calculates, every sampling period, a total acceleration of the accelerometer to determine if the upper platen is in motion.

8. The upper platen assembly of claim 7, wherein the at least one processor determines that the upper platen is in motion when the total acceleration is outside a total acceleration range of +/−0.1 g from a neutral acceleration measurement.

9. The upper platen assembly of claim 8, wherein the at least one processor discards the output signals from any sampling period wherein the total acceleration is outside the total acceleration range.

10. The upper platen assembly of claim 7, wherein the total acceleration is a square root of a sum of the output signals squared, the output signals including an x-axis signal, a y-axis signal and a z-axis signal.

11. The upper platen assembly of claim 4, wherein the at least one processor calculates an instantaneous inclination angle for use in determining the inclination angle, the instantaneous inclination angle being an inverse tangent of the x-axis signal divided by the z-axis signal.

12. The upper platen assembly of claim 11, wherein the at least one processor calculates the instantaneous inclination angle by sampling the output signals once every sampling period, the at least one processor being configured to calculate an average inclination angle every sampling period from the instantaneous inclination angle.

13. The upper platen assembly of claim 12, wherein the average inclination angle for each sampling period is 90% of an average inclination angle for a prior sampling period plus 10% of the instantaneous inclination angle of a current sampling period.

14. The upper platen assembly of claim 13, wherein the at least one processor determines that the inclination angle indicates that the upper platen is in the lowered position if the average inclination angle of a current sampling period is less than a threshold angle.

15. The upper platen assembly of claim 14, wherein the threshold angle is approximately seven degrees.

16. The upper platen assembly of claim 14, wherein the at least one processor determines that the inclination angle corresponds to the upper platen being in the lowered position after the average inclination angle of each of a predetermined number of successive sampling periods is less than the threshold angle.

17. An upper platen assembly for a griddle, comprising:
a plurality of arms pivotally connected to the griddle;
an upper platen carried by the plurality of arms between a lowered position wherein the upper platen is adjacent a cooking surface of the griddle and a raised position wherein the upper platen is spaced apart from the cooking surface; and
a control assembly coupled to and movable with the upper platen, the control assembly including an electrical system comprising:
at least one processor configured to execute a plurality of instructions; and
an accelerometer configured to provide output signals to the at least one processor;
wherein the at least one processor is configured to execute the plurality of instructions to determine whether the upper platen is in the raised position or the lowered position by calculating an inclination angle of the upper platen relative to the cooking surface using the output signals from the accelerometer, determining that the upper platen is in the raised position if the inclination angle is greater than or equal to a predetermined threshold, and determining that the upper platen is in the lowered position if the inclination angle is less than the predetermined threshold; and
wherein the at least one processor is configured to automatically initiate at least one operation of the griddle in response to determining that the upper platen is in the lowered position.

18. A method for determining a position of an upper platen of a griddle relative to a cooking surface of the griddle, comprising:
sampling, by at least one processor, output signals from an accelerometer mounted to the upper platen, once every sampling period;
determining, by the at least one processor once every sampling period, whether the upper platen is in a raised position or a lowered position by:
calculating an instantaneous inclination angle from the output signals;
calculating an average inclination angle from the instantaneous inclination angle;
determining that the upper platen is in a raised position when the average inclination angle is greater than or equal to a threshold angle; and
determining that the upper platen is in a lowered position when the average inclination angle is less than the threshold angle.

19. The method of claim 18, wherein determining, by the at least one processor once every sampling period, whether the upper platen is in the raised position or the lowered position further comprises:
calculating a total acceleration from the output signals; and
discarding the output signals for a current sampling period in response to the total acceleration falling outside a total acceleration range.

20. The method of claim 18, wherein determining that the upper platen is in a raised position includes determining that the average inclination angle is greater than or equal to the threshold angle for each of a predetermined number of successive sampling periods.
